(19) United States
(12) Patent Application Publication
(10) Pub. No.: US 2011/0232299 A1
(43) Pub. Date: Sep. 29, 2011

(54) IMPINGEMENT STRUCTURES FOR COOLING SYSTEMS

(76) Inventors: Sergey Aleksandrovich Stryapunin, Moscow (RU); Sergey Anatolievich Meshkov, Moscow (RU)

(21) Appl. No.: 13/043,760

(22) Filed: Mar. 9, 2011

(30) Foreign Application Priority Data
Mar. 25, 2010 (RU) 2010111235

(51) Int. Cl. F02C 7/12; F28D 15/00

(52) U.S. Cl. 60/806; 165/104.11

(57) ABSTRACT

An impingement structure 204 in an impingement cooling system, wherein the impingement structure 204 comprises a plurality of impingement apertures 214 that are configured to impinge a flow of coolant and direct resulting coolant jets against a target-surface 210 that opposes the impingement structure 204 across an impingement cavity 212 formed therebetween, the impingement structure 204 comprising a corrugated configuration.

### BACKGROUND OF THE INVENTION

This present application relates generally to apparatus and/or systems for improving the efficiency and/or operation of impingement cooling. More specifically, but not by way of limitation, the present application relates to apparatus and/or systems for cooling combustion engine parts via the circulation and impingement of a flow of coolant by an impingement sleeve of a novel configuration, and, more particularly, an improved impingement sleeve for use in the combustion system of a combustion turbine engine. (Note that, while the present invention is presented below in relation to one of its preferred usages in the combustion system of a combustion turbine engine, those of ordinary skill in the art will appreciated that the usage of the invention described herein is not so limited, as it may be applied to impingement cooling applications in other components of combustion turbine engines as well as in the impingement cooling systems in other types of industrial machines or combustion engines.)

Many types of industrial machines and engines already push the temperature limitations of the materials uses to construct them. Often, however, performance benefits could be achieved if the machines/engines could be made to withstand higher operating temperatures. For example, in the case of combustion turbine engines, as with any heat engine, higher firing temperatures correlate to higher engine operating efficiencies. One way to achieve these higher temperatures is to cool the relevant parts of the engine so that these parts may withstand the higher temperatures. One cooling method that has been applied extensively in combustion turbine engines employs a stream of pressurized coolant that is directed through internal passageways to the components that require it. In the case of combustion turbine engines, the coolant typically is pressurized air that is extracted from the compressor.

The coolant, once delivered, may be employed in several ways to cool the part. One common scenario includes applying the coolant along an interior wall of the part that is subjected to extreme temperatures on its exterior side. The wall of the part may be relatively narrow so that the coolant applied to the interior surface maintains exterior surface of the wall at an acceptable temperature. That is, the coolant removes heat from the wall, which generally allows the part to remain relatively cool and effectively withstand higher temperatures. As will be appreciated by one of ordinary skill in the art, the effectiveness of the coolant is enhanced if it is applied against the wall as high-pressure, high-velocity jets. This type of cooling is often referred to as impingement cooling, and, as discussed in more detail below, includes an impingement structure, which also may be referred to as an impingement insert or sleeve. In general, the impingement sleeve is a structure that receives a flow of pressurized coolant and then applies the coolant against a heated surface in a desired manner by impinging the flow through a number of narrow apertures, which are commonly referred to as impingement apertures.

However, conventional arrangements and configurations of impingement structures allow the cooling effects of the impinged coolant to be negatively impacted by the cross-flow of already exhausted coolant (i.e., post-impingement coolant that has already been applied against the heated-surface and is flowing toward an outlet). As discussed in detail below, the flow of exhausted-coolant degrades the effectiveness of the newly arriving coolant by redirecting or interrupting its flow toward the surface of the part so that it does not strike the surface in an ideal manner in terms of cooling effectiveness. The exhausted-coolant also may create boundary layers that further negatively impact the cooling effects of the newly arriving, fresh coolant. In short, conventional impingement cooling is generally disadvantaged by post-impingement cross-flow degradation effects. As a result, there is a need for improved impingement cooling apparatus and systems that reduce this type of cooling system degradation.

### BRIEF DESCRIPTION OF THE INVENTION

The present application thus describes an impingement structure in an impingement cooling system, wherein the impingement structure includes a plurality of impingement apertures that are configured to impinge a flow of coolant and direct resulting coolant jets against a target-surface that opposes the impingement structure across an impingement cavity formed therebetween, the impingement structure comprising a corrugated configuration. The impingement structure resides in spaced relation to the target surface. In some embodiments, the target-surface comprises an outer surface of a liner and the impingement structure comprises a flow sleeve in a combustor of a combustion turbine engine. In some embodiments, the target-surface comprises an outer surface of a transition piece and the impingement structure comprises an impingement sleeve in a combustor of a combustion turbine engine.

At a coolant-side of the impingement structure, a coolant cavity may reside through which, in operation, the flow of coolant is directed so that the coolant is forced against the coolant-side of the impingement structure and thereby impinged through the impingement apertures. At an impingement side of the impingement structure the impingement cavity may reside.

The corrugated configuration may include a plurality of parallel and alternating ridges and grooves. The ridges may include a portion of the corrugated configuration that extends toward the target-surface. The grooves may include a portion of the corrugated configuration that resides in a recessed position in relation to the target-surface such that the ridges reside closer to the target surface than the grooves. At least a majority of the impingement apertures may be disposed on the ridges.

Along the impingement-side of the impingement structure, the ridges may include a ridge face, wherein the ridge face may include a broad face formed at the outer reaches of the ridges that extends the length of the ridges and is approximately parallel to the target-surface. Along the coolant-side of the impingement structure, the ridges may include a ridge channel that is in flow communication with the coolant cavity through an inlet mouth, the ridge channel extending toward the target-surface from the inlet mouth to the ridge face. Along the impingement-side of the impingement structure, the grooves may include a groove channel, the groove channel comprising a channel that begins at an outflow mouth and extends away from the target-surface to a floor, the floor being positioned a greater distance from the target-surface than the ridge face.

The ridge channel may be configured such that, during operation, the coolant enters the ridge channel at the inlet mouth, flows toward the ridge face, and exits the ridge channel via the impingement apertures. The groove channel may be configured to collect exhausted-coolant after the coolant strikes the target-surface such that the exhausted-coolant enters the groove channel at the outflow mouth, collects into the groove channel, and then flows along the longitudinal axis of the groove channel toward an outlet. A longitudinal axis of the grooves may be aligned to point toward the outlet. Sidewalls may extend from each side of the inlet mouth to a corresponding side of the ridge face, the sidewalls defining the ridge channel from the inlet mouth to the ridge face. The sidewalls may extend from each side of the outflow mouth to a corresponding side of the floor, the sidewalls defining the groove channel from the outflow mouth to the floor.

In some embodiments, substantially all of the impingement apertures are disposed on the ridge face. The ridge face may be substantially flat or slightly curved. The floor may be substantially flat or slightly curved. The ridge may be configured such that the ridge face resides in close proximity to the target-surface.

The corrugated configuration may include a flared configuration such that: the ridge channel is narrow at the inlet mouth and the sidewalls of the ridge channel flare outwards from the narrow inlet mouth so that the ridge channel broadens as it nears the backside surface of the ridge face; and the groove channel is narrow at the outflow mouth and the sidewalls of the groove channel flare outwards from the narrow outflow mouth so that the groove channel broadens as it nears the floor. The corrugated configuration may include a rectangular configuration or a sinusoidal configuration. If the corrugated configuration includes the sinusoidal configuration, the ridge face may present a curved, convex surface to the impingement cavity and the floor may present a curved, concave surface to the groove channel.

These and other features of the present application will become apparent upon review of the following detailed description of the preferred embodiments when taken in conjunction with the drawings and the appended claims.

### BRIEF DESCRIPTION OF THE DRAWINGS

These and other aspects of this invention will be more completely understood and appreciated by careful study of the following more detailed description of exemplary embodiments of the invention taken in conjunction with the accompanying drawings, in which:

FIG. 1 is a schematic representation of an exemplary turbine engine in which embodiments of the present application may be used;

FIG. 2 is a sectional view of an exemplary compressor that may be used in the gas turbine engine of FIG. 1;

FIG. 3 is a sectional view of an exemplary turbine that may be used in the gas turbine engine of FIG. 1;

FIG. 4 is a sectional view of an exemplary can combustor that may be used in the gas turbine engine of FIG. 1;

FIG. 5 is a cross sectional view of a conventional impingement cooling arrangement;

FIG. 6 is a cross-sectional view of a impingement structure according to an exemplary embodiment of the present application;

FIG. 7 is a perspective view of the impingement structure of FIG. 6;

FIG. 8 is a top view of the impingement structure of FIG. 6;

FIG. 9 is a cross-sectional view of an impingement structure according to an alternative embodiment of the present application;

FIG. 10 is a perspective view of the impingement structure of FIG. 9 as it may be used with a transition piece with a can combustor of a turbine engine; and

FIG. 11 is a cross-sectional view of an impingement structure according to an alternative embodiment of the present application.

### DETAILED DESCRIPTION OF THE INVENTION

As stated above and as follows, the present invention is presented in relation to one of its preferred usages in the combustion system of a combustion turbine engine. Hereinafter, the present invention will be primarily described in relation to this usage; however, this description is exemplary only and not intended to be limiting except where specifically made so. Those of ordinary skill in the art likely will appreciated that the usage of the present invention may be applied to impingement cooling applications in other components of combustion turbine engines as well as in impingement cooling systems in other types of industrial machines or combustion engines.

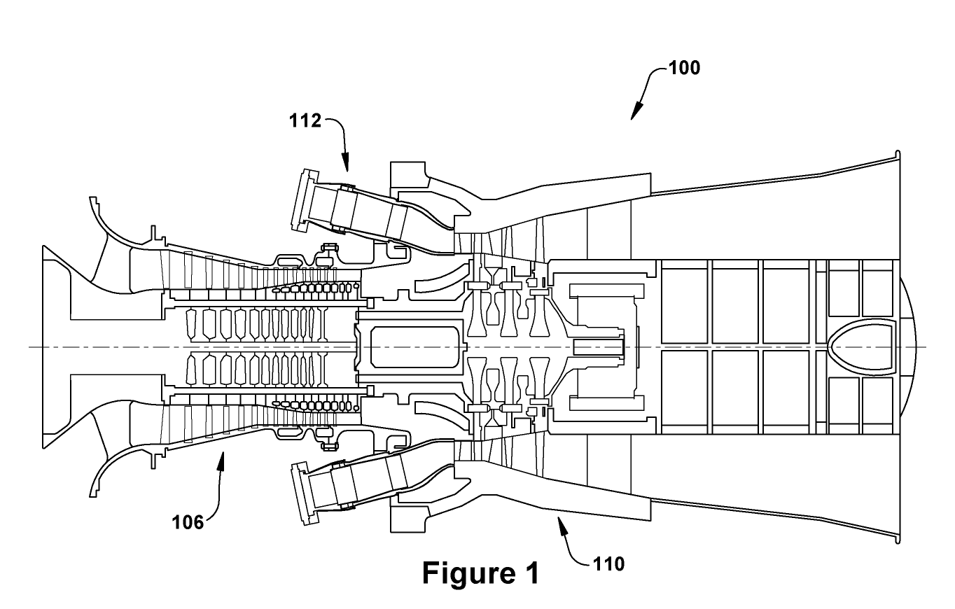

Referring now to the figures, FIG. 1 illustrates a schematic representation of a gas turbine engine 100. In general, gas turbine engines operate by extracting energy from a pressurized flow of hot gas that is produced by the combustion of a fuel in a stream of compressed air. As illustrated in FIG. 1, gas turbine engine 100 may be configured with an axial compressor 106 that is mechanically coupled by a common shaft or rotor to a downstream turbine section or turbine 110, and a combustion system 112, which, as shown, is a can combustor that is positioned between the compressor 106 and the turbine 110.

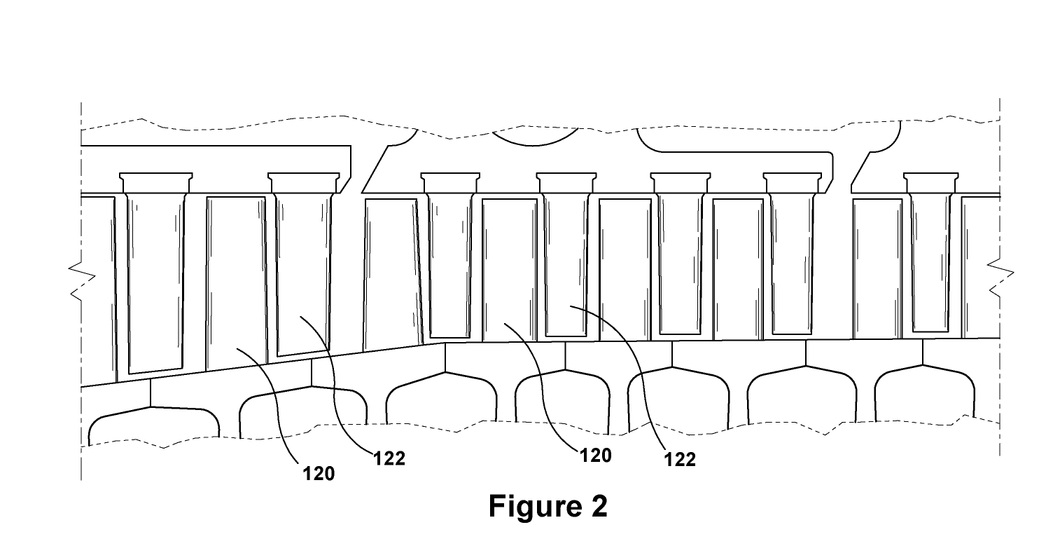

FIG. 2 illustrates a view of an axial compressor 106 that may be used in gas turbine engine 100. As shown, the compressor 106 may include a plurality of stages. Each stage may include a row of compressor rotor blades 120 followed by a row of compressor stator blades 122. Thus, a first stage may include a row of compressor rotor blades 120, which rotate about a central shaft, followed by a row of compressor stator blades 122, which remain stationary during operation. The compressor stator blades 122 generally are circumferentially spaced one from the other and fixed about the axis of rotation. The compressor rotor blades 120 are circumferentially spaced about the axis of the rotor and rotate about the shaft during operation. As one of ordinary skill in the art will appreciate, the compressor rotor blades 120 are configured such that, when spun about the shaft, they impart kinetic energy to the air or working fluid flowing through the compressor 106. As one of ordinary skill in the art will appreciate, the compressor 106 may have many other stages beyond the stages that are illustrated in FIG. 2. Each additional stage may include a plurality of circumferential spaced compressor rotor blades 120 followed by a plurality of circumferentially spaced compressor stator blades 122.

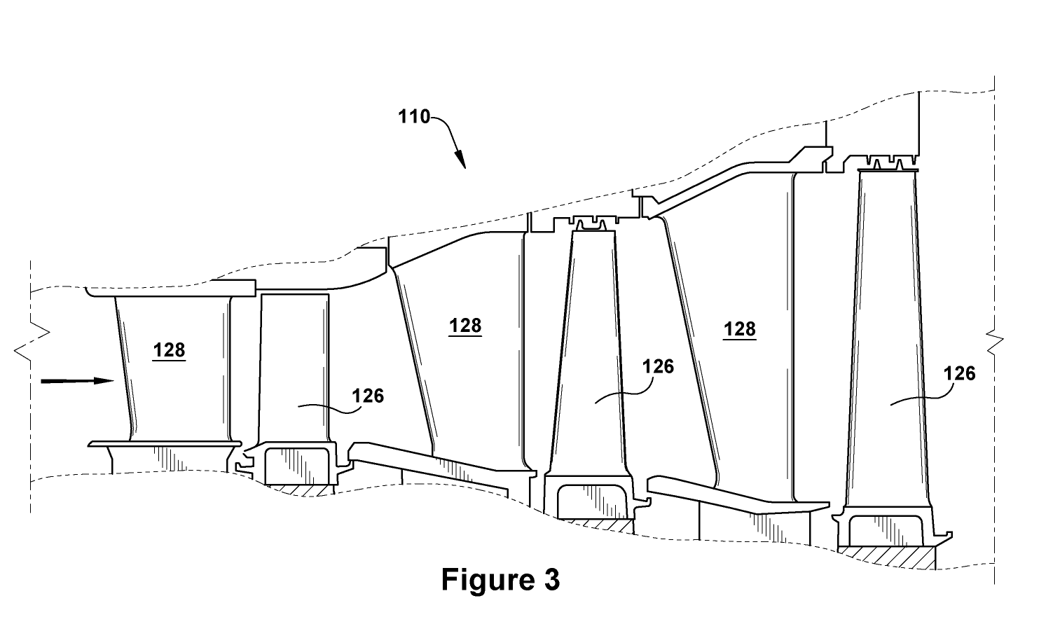

FIG. 3 illustrates a partial view of an exemplary turbine section or turbine 110 that may be used in a gas turbine engine 100. The turbine 110 may include a plurality of stages. Three exemplary stages are illustrated, but more or less stages may be present in the turbine 110. A first stage includes a plurality of turbine buckets or turbine rotor blades 126, which rotate about the shaft during operation, and a plurality of nozzles or turbine stator blades 128, which remain stationary during operation. The turbine stator blades 128 generally are circumferentially spaced one from the other and fixed about the axis of rotation. The turbine rotor blades 126 may be mounted on a turbine wheel (not shown) for rotation about the shaft (not shown). A second stage of the turbine 110 is also illustrated. The second stage similarly includes a plurality of circumferentially spaced turbine stator blades 128 followed by a plurality of circumferentially spaced turbine rotor blades 126, which are also mounted on a turbine wheel for rotation. A third stage also is illustrated, and similarly includes a plurality of circumferentially spaced turbine stator blades 128 and turbine rotor blades 126. It will be appreciated that the turbine stator blades 128 and turbine rotor blades 126 lie in the hot gas path of the turbine 110. The direction of flow of the hot gases through the hot gas path is indicated by the arrow. As one of ordinary skill in the art will appreciate, the turbine 110 may have many other stages beyond the stages that are illustrated in FIG. 3. Each additional stage may include a plurality of circumferential spaced turbine stator blades 128 followed by a plurality of circumferentially spaced turbine rotor blades 126.

A gas turbine engine of the nature generally described above may operate as follows. The rotation of compressor rotor blades 120 within the axial compressor 106 compresses a flow of air. In the combustor 112, as described in more detail below, energy is released when the compressed air is mixed with a fuel and ignited. The resulting flow of hot gases from the combustor 112 then may be directed over the turbine rotor blades 126, which may induce the rotation of the turbine rotor blades 126 about the shaft, thus transforming the energy of the hot flow of gases into the mechanical energy of the rotating shaft. The mechanical energy of the shaft may then be used to drive the rotation of the compressor rotor blades 120, such that the necessary supply of compressed air is produced, and also, for example, a generator to produce electricity.

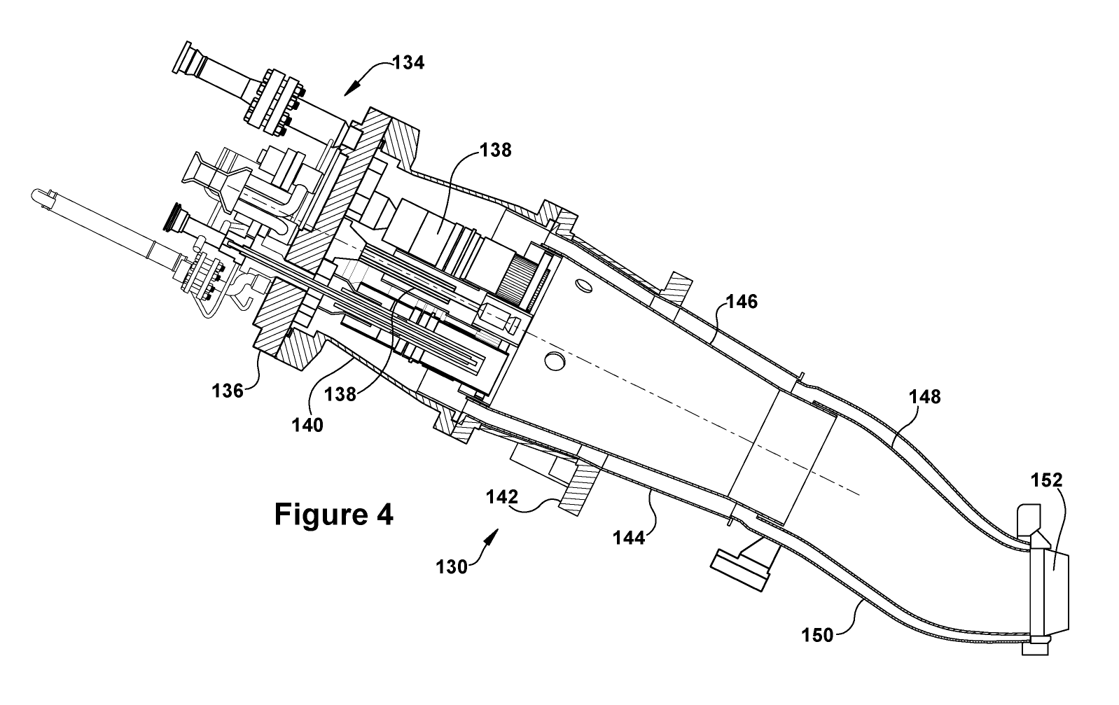

FIG. 4 illustrates an exemplary can combustor 130 that may be used in a gas turbine engine. As described in more detail below, preferred embodiments of the present invention may be employed in aspects of the can combustor 130. As one of ordinary skill in the art will appreciate, the combustor can 130 may include a headend 134, which generally includes the various manifolds that supply the necessary air and fuel to the can combustor, and an end cover 136. A plurality of fuel nozzles 138 may be fixed to the end cover 136. The fuel nozzles 138 provide a mixture of fuel and air for combustion. The fuel, for example, may be natural gas and the air may be compressed air supplied from an axial compressor (not shown in FIG. 4) that is part of the gas turbine engine. The fuel nozzles 138 may be located inside of a forward case 140 that attaches to the end cover 136 and encloses the fuel nozzles 138. As one of ordinary skill in the art will appreciate, downstream of the fuel nozzles 138, generally, an aft case 142 may enclose a flow sleeve 144. The flow sleeve 144, in turn, may enclose a liner 146, creating a channel between the flow sleeve 144 and the liner 146. From the liner 146, a transition piece 148 transitions the flow from a circular cross section of the liner to an annular cross section as it travels downstream to the turbine 110 (not shown in FIG. 4). A transition piece impingement sleeve 150 (hereinafter “impingement sleeve 150”) encloses the transition piece 148, creating a channel between the impingement sleeve 150 and the transition piece 148. At the downstream end of the transition piece 148, a transition piece aft frame 152 may direct the flow of the working fluid toward the airfoils that are positioned in the first stage of the turbine 110.

It will be appreciated that the flow sleeve 144 and the impingement sleeve 150 may have impingement apertures (not shown in FIG. 4) formed therethrough which allow an impinged flow of compressed air from the compressor to enter the cavities formed between the flow sleeve 144 and the liner 146 and between the impingement sleeve 150 and the transition piece 148. As discussed in more detail below, the flow of compressed air may be used to convectively cool the exterior surfaces of the liner 146 and the transition piece 148.

In use, the can combustor 130 may operate as follows. A supply of compressed air from the compressor 106 may be directed to the space surrounding the flow sleeve 144 and the impingement sleeve 150. The compressed air then is impinged through the impingement apertures formed through the flow sleeve 144 and the impingement sleeve 150, thereby entering the can combustion 130. The impinged flow of compressed air is directed against the exterior surfaces of the flow sleeve 144 and the transition piece 148, which cools these components. The compressed air then moves through the channel formed between the impingement sleeve 150 and the transition piece 148, and, from there, through the channel formed between the flow sleeve 144 and the liner 146, in the direction of the headend 134. The compressed air then flows into the volume bound by the forward case 140 and enters the fuel nozzles 138 through an inlet flow conditioner. At the fuel nozzles 138, generally, the supply of compressed air may be mixed with a supply of fuel, which is provided by a fuel manifold that connects to the fuel nozzles 138 through the end cover 136. The supply of compressed air and fuel is combusted as it exits the fuel nozzles 138, which creates a flow of rapidly moving, extremely hot gases that is directed downstream through the liner 146 and transition piece 148 to the turbine 110, where the energy of the hot-gases is converted into the mechanical energy of rotating turbine blades.

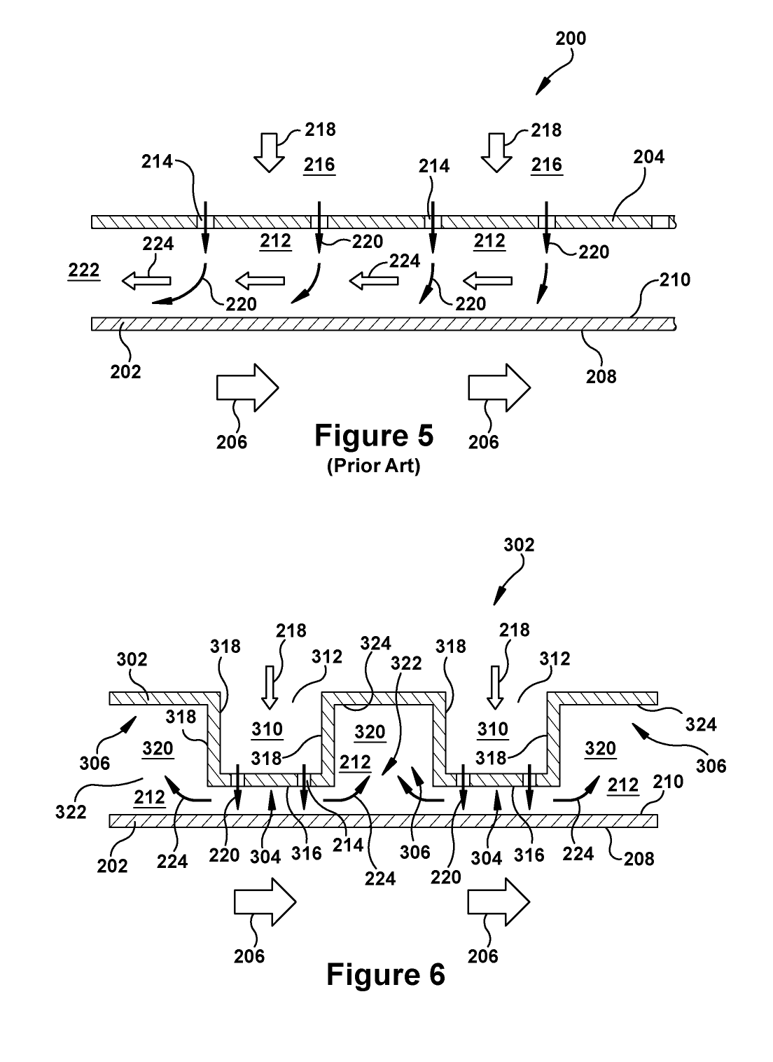

Referring to FIG. 5, a conventional impingement cooling arrangement 200 is shown. This arrangement generally includes a structure that is cooled via a flow of impinged coolant (the cooled structure being represented by a wall 202). In spaced relation to the wall 202, there is an impingement structure 204. It will be appreciated that the wall 202 may represent any part or structure that is exposed to extreme temperatures on one side and cooled on the other, and the impingement structure 204 may represent the part or structure that accepts a flow of coolant and impinges the coolant and directs the impinged flow against the wall 202. For example, as discussed above, the wall 202 may represent the transition piece 148 and the impingement structure may represent the impingement sleeve 150. In another embodiment, the wall 202 may represent the liner 146 and the impingement structure 204 may represent the flow sleeve 144. In either case, the arrows 206 would represent the flow of hot-gases through the combustor 130. It will be appreciated that the wall 202 may be described as having a heated-surface 208, which is the side that is exposed to the extreme temperatures of the hot-gases, and a target-surface 210, which generally is the opposite side of the wall 202 as the heated-surface 208 and the surface that opposes the impingement structure 204 and against which coolant is aimed.

In a conventional arrangement, as shown in FIG. 5, the impingement structure 204 is flat or substantially flat and, typically, configured such that it resides an approximately constant distance from the wall 202. In this manner, the impingement structure 204 forms an impingement cavity 212 between itself and the wall 202. As shown, the impingement structure 204 includes a number of impingement apertures 214. It will be appreciated that on the other side of the impingement structure 204, a coolant cavity 216 is provided. The coolant cavity 216 is the cavity where the supply of pressurized coolant (the flow of which is represented by arrows 218) is directed so that the pressurized coolant may be forced or impinged through the impingement apertures 214. Intensified in this manner, the coolant is transformed into a number of high velocity coolant jets (the flow of which is represented by arrows 220) that are aimed against the wall 202. It will be appreciated that the central idea of this cooling technique is the use of the high heat transfer coefficient (HTC) that results when the coolant jets are trained against a nearby target surface so that heat is convected from the target surface at a high rate.

After the coolant jets are exhausted against the wall 202, it will be appreciated that the exhausted coolant then flows toward an outlet that may be provided to the impingement cavity 212. In FIG. 5, a cavity outlet 222 represents the outlet to the impingement cavity 212. It is this general cross-flow of exhausted-coolant (the flow of which is represented by arrows 224) that, as described, degrades the cooling effectiveness of the incoming, fresh coolant. More particularly, as illustrated in FIG. 5 by the orientation of the arrows depicting the coolant jets and the size of the arrows depicting the exhausted-coolant cross-flow, the strength of the exhausted-coolant cross-flow generally strengthens as it nears the cavity outlet 222. The strengthened cross-flow may redirect the coolant jets so that the coolant jets no longer strike the wall 202 at a perpendicular angle or an angle that is close to perpendicular. This, it will be appreciated, has a negative impact on the cooling effectiveness of the coolant jets. This type of degradation often is referred to as jet-vector alteration. The exhausted-coolant cross-flow alters the direction of the coolant jets so that the jet no longer strike the target surface in a perpendicular manner, which decreases its cooling effectiveness.

In addition, given the general flow patterns of conventional impingement cooling arrangements as shown in FIG. 5, it will be appreciated that significant amounts of exhausted-coolant crosses in front of other impingement apertures 214 (i.e., between the impingement apertures 215 and the wall 202) as the exhausted coolant makes its way toward cavity outlet 222, and particularly as the flow nears the outlet 222, creating a boundary layer of higher-temperature coolant that degrades cooling effectiveness further. More specifically, because of the heat already absorbed from the wall 202 by the exhausted-coolant, the exhausted-coolant cross-flow is at a higher temperature than fresh coolant entering the cavity 216 in one of the impingement jets. As one of ordinary skill in the art will appreciate, the exhausted-coolant cross-flow impedes the cooling of the wall 202 by mixing with the fresh coolant and, thereby, raising the temperature of the coolant jets and reducing the temperature differential between the wall 202 and flow of coolant against it. This boundary layer effect reduces the heat transfer coefficient between the coolant and wall 202 and, thereby, degrades cooling effectiveness.

If the cross-flow of exhausted-coolant were reduced within the coolant cavity 216 or redirected such that it did not impede fresh coolant from flowing directly against the wall 202 and did not create a boundary layer of exhausted-coolant that the fresh coolant must penetrate, the heat exchange between the fluid coolant and the wall generally would be improved. As one of ordinary skill in the art will appreciate, such an improvement in cooling effectiveness would reduce the amount of coolant required to maintain the wall 202 at a desired temperature. In certain applications, such as the use of compressed air to cool turbine stator blades, it will be appreciated that use of coolant has a negative impact on the efficiency of combustion turbine engines. Accordingly, a reduction in its usage increases the efficiency of the engine.

Referring now to FIGS. 6 through 8, several views of an impingement structure 302 that includes a corrugated configuration according to an exemplary embodiment of the present application is shown. As shown, per the corrugated configuration, the impingement structure 302 includes a plurality of parallel and alternating ridges 304 and grooves 306. The ridges 304, as used herein, are the portion of the corrugated form that extends toward the target-surface 210. In comparison, the grooves 306 are the portion of the corrugated form that resides in a recessed position in relation to the target-surface 210. It will be appreciated that the ridges 304 generally reside closer to the target surface 210 than the grooves 306. Further, in accordance with embodiments of the present invention, a number of impingement apertures 214 may be located on the ridges 304 of the impingement structure 302.

The impingement structure 302 may be described as having a coolant-side, against which a supply of coolant is applied (as indicated by arrows 218), and an impingement side, from which the coolant jets 220 are expelled from the impingement apertures 214 (as indicated by arrows 220). It will be appreciated that the impingement side of the impingement structure 302 faces the target-surface 210, and forms an impingement cavity 212 therebetween.

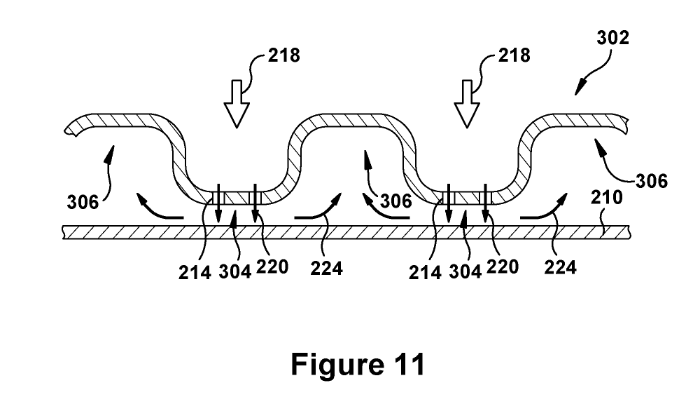

Along the coolant-side of the impingement structure 302, the ridges 304 may be formed to include a ridge channel 310 through which the coolant flows to the impingement apertures 214. More particularly, the ridge channel 310 may be configured such that, during operation, the coolant enters the ridge channel 310 at an inlet mouth 312 and flows toward the opposing end of the ridge channel where it then exits via the impingement apertures 214. Along the impingement-side of the impingement structure 302, it will be appreciated that the ridge 304 may be formed to include a ridge face 316. The ridge face 316 generally comprises a broad face formed at the outer reaches of the ridge 304 that is approximately parallel to the target-surface 210. The ridge face 316 may be flat, as shown in FIG. 6, or slightly curved, an example of which is shown in FIG. 11. In general, the ridge 304 is configured such that the ridge face 316 resides in close proximity to the target-surface 210. Also, a majority or all of the impingement apertures 214 may be located on the ridge face 316, as shown in FIG. 5. Sidewalls 318 extend from each side of the inlet mouth 312 to corresponding side of the ridge face 316. The sidewalls 318 generally define the ridge channel 304 between the inlet mouth 312 and the ridge face 316.

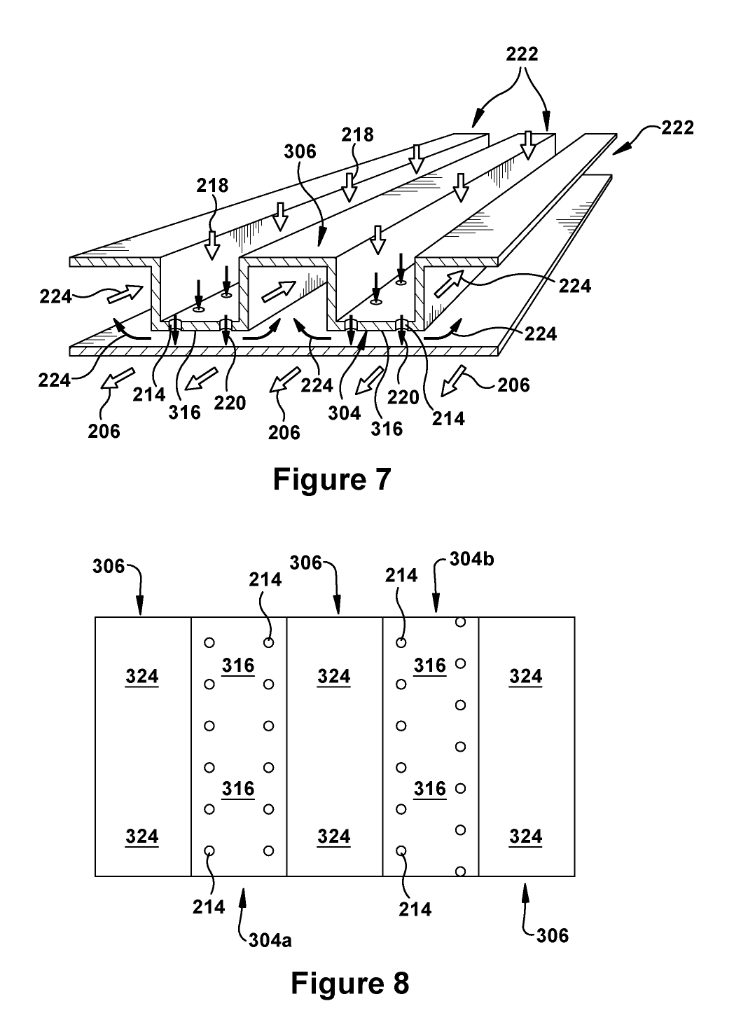

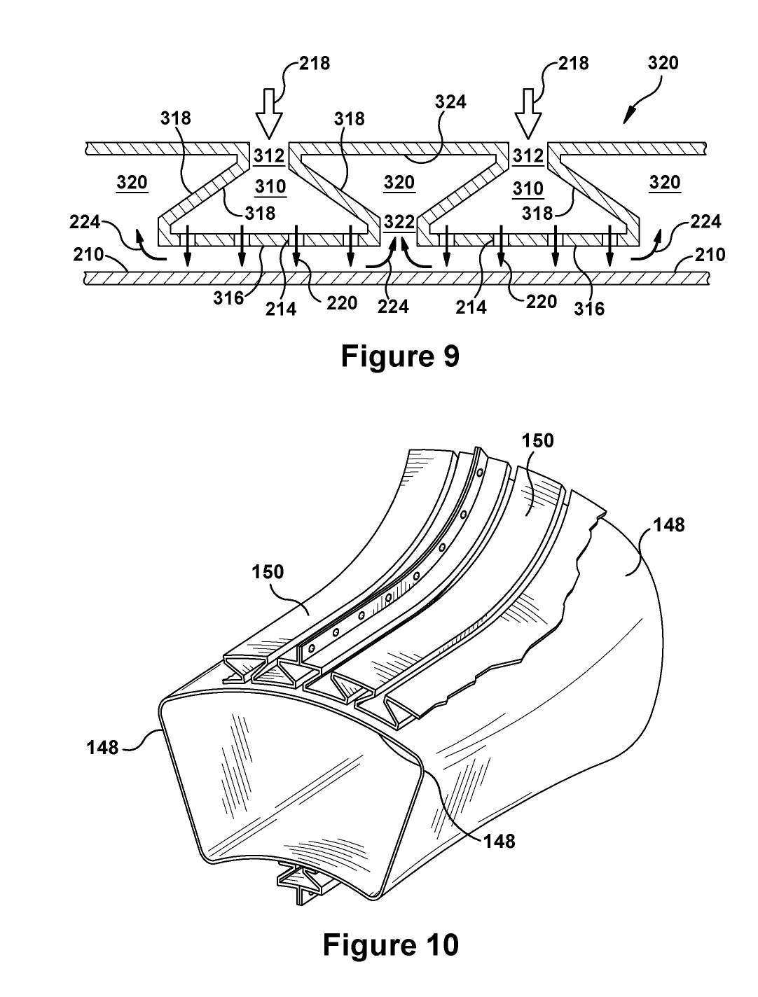

Along the impingement-side of the impingement structure 302, the grooves 306 may be formed to include a groove channel 320. It will be appreciated that the groove channel 320 comprises a channel that begins at an outflow mouth 322 and extends away from the target-surface 210 to a floor 322. It will be appreciated that, given the corrugated configuration of the impingement structure, the floor 324 is positioned a greater distance from the target-surface 210 than the ridge face 316. As shown in FIG. 5, the groove channel 320 generally is configured to collect exhausted-coolant (the flow of which is depicted by arrows 224) after the coolant strikes the target-surface 210. More specifically, the exhausted-coolant enters the groove channel 320 at the outflow mouth 322, collects into the groove channel 320, and then flows along the longitudinal axis of the groove channel 320 toward the lower pressures associated with an outlet 222 (as shown in FIG. 8). It will be appreciated that in certain preferred embodiments, the longitudinal axis of the ridges 304 and the grooves 306 are aligned so that they generally point toward the outlet 222, as shown in FIGS. 7 and 9. The floor 324 generally may be flat or slightly curved. The sidewalls 318 generally define the groove channel 306 between the outflow mouth 322 and the floor 324.

In some embodiments, the locations of the impingement apertures 214 comprise a pattern on the ridge face 316. In some embodiments, as shown in FIGS. 7 and 8, two rows of impingement apertures 214 may be located along the ridge face 316. In this case, the two rows of impingement apertures 214 may be located at the edge of the ridge face 316 so that a row of impingement apertures 214 borders each of the two neighboring grooves 306. That is, one row of impingement apertures 214 is positioned on one side of the ridge face 316 so that the impingement apertures 214 reside in close proximity to the outflow mouth 322 of the groove 306 positioned on that side of the ridge face 316, while the other row is positioned on the other side of the ridge face 316 so that the impingement apertures 214 are near the outflow mouth 322 of the groove 306 positioned to that side. In this manner, each impingement aperture 214 generally is located near an outflow mouth 322.

In some embodiments, the rows of impingement apertures 214 may be substantially parallel to the edge of the neighboring outflow mouth and reside in relatively close proximity thereto, an example of which is most visibly shown in FIG. 8. It will be appreciated that, in this type of embodiment, the post-impingement flow (i.e., the flow of exhausted-coolant) associated with each row of impingement apertures 214 may flow to an outflow mouth 322 without crossing in front of the flow from another row of impingement apertures 214, which, during operation, will reduce the amount of cross-flow that occurs and reduce the resulting cross-flow degradation that occurs as a result of it.

In some embodiments, additional rows of impingement apertures 214 may be positioned between the two rows that border the neighboring grooves 306 to each side. In this case, an increased amount of exhausted-coolant cross-flow may occur compared to the embodiment having only two rows of impingement apertures 214. However, as one of ordinary skill in the art will appreciate, this type of embodiment still has performance advantages over conventional designs. In addition, a single row of impingement apertures 214 is also possible. In this case, the impingement apertures 214 may be positioned in the approximate middle of the ridge face 316. The single row embodiment (not shown) also may result in a reduced level of exhausted-coolant cross-flow when compared to conventional design.

As shown in FIG. 8, in each of the rows, the impingement apertures 214 may be regularly spaced and the spacing may be the same for both or all of the rows. In cases such as this, the impingement apertures 214 between the rows may be clocked against each other. In one embodiment, as shown on the ridge 304a of FIG. 8, the impingement apertures 214 of two neighboring rows may directly align. In this case, the position along the longitudinal axis of the ridge 304a of an impingement aperture 214 in one row may be the approximate same as the corresponding impingement aperture 214 in the neighboring row. In another embodiment, as shown on the ridge 304b of FIG. 8, the impingement apertures 214 of two neighboring rows may be staggered. In this case, the longitudinal position of corresponding impingement apertures 214 is not the same. For example, in one preferred embodiment, as shown in the ridge 304b, the longitudinal position of the impingement apertures 214 occurs at the approximate mid-point of the corresponding pair in the other row.

FIG. 9 illustrates an impingement structure 302 that includes an alternative corrugated configuration according to an exemplary embodiment of the present application. In this embodiment, the corrugated configuration is flared, i.e., formed so that the ridge face 316 is broad and the outflow mouth 322 narrow. As shown, the ridge channel 310 is narrow at the inlet mouth 312. The sidewalls 318 of the ridge channel 310 flare or angle outwards from the narrow inlet mouth 312 so that the ridge channel 310 broadens as it nears the backside of the ridge face 316. The configuration of the groove channel 320 is similar, though reversed in orientation. That is, the groove channel 320 is narrow at the outflow mouth 322. The sidewalls 318 of the groove channel 320 flare or angle outwards from the narrow outflow mouth 322 so that the groove channel 320 broadens as it nears the floor 324. It will be appreciated that, compared to the corrugated configuration of FIGS. 6-8, configurations like the one shown in FIG. 9 allow for an increased ridge face 316 surface area, which allows for more surface area on which to place impingement apertures 214, while also creating a channel into which exhausted coolant may collect and flow to an outlet.

In the design of corrugated configurations like the one in FIG. 9, it has been discovered that certain ratios that pertain to the width of the ridge face 316 compared to the width of the outflow mouth 322 provide enhanced performance. For example, if the width of the ridge face 316 is too large compared to the width of the outflow mouth 322, then the outflow mouth 322 may be insufficient to accommodate a sufficient flow of exhausted-coolant into the groove 306. It will be appreciated that this may result in an increased level of exhausted-coolant cross-flow. At the other end of the design spectrum, a ridge face 316 that is too narrow may not have the area for a sufficient number of impingement apertures 214, which may leave areas of the target surface 210 insufficiently cooled. In preferred embodiments of the present invention, it has been determined that the width of the ridge face 316 should be between 2 and 5 times the width of the outflow mouth 322. In more-preferred embodiments, the width of the ridge face 316 should be between 3 and 4 times the width of the outflow mouth 322.

FIG. 10 provides a cut-away view illustrating how the embodiment of FIG. 9 maybe used as an impingement sleeve 150 to the transition piece 148 of a combustion turbine engine. As shown, the impingement sleeve 150 may reside in spaced relation to the outer surface of the transition piece 148. The longitudinal axis of the ridges 304 and grooves 306 may be aligned so that they are parallel with the direction of flow through the transition piece 148. In this manner, the grooves 306 allow the exhausted-coolant flow to efficiently travel toward the outlet at the upstream edge of the transition piece 148.

FIG. 11 illustrates an impingement structure 302 that includes an alternative corrugated configuration. FIG. 7 illustrates a corrugated configuration that is rectangular. As shown in FIG. 11, the corrugated configuration of the present invention also may have a curved, snaking or sinusoidal configuration. In this embodiment, it will be appreciated that the ridge face 316 is slightly curved and generally presents a convex surface to impingement cavity. The floor 324 of the groove 306 also may be slightly curved in this type of embodiment, however, it will be appreciated that the floor 324 generally presents a concave surface toward the impingement cavity. In other embodiments, the curvature may be exaggerated such that an embodiment similar to the one of FIG. 9 is produced (i.e., one with a broad ridge face 316 and narrow outflow mouth 322).

From the above description of preferred embodiments of the invention, those skilled in the art will perceive improvements, changes and modifications. Such improvements, changes and modifications within the skill of the art are intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

What is claimed is:

1. An impingement structure 302 in an impingement cooling system, wherein the impingement structure 302 comprises a plurality of impingement apertures 214 that are configured to impinge a flow of coolant and direct resulting coolant jets against a target-surface that opposes the impingement structure 302 across an impingement cavity 212 formed therebetween, the impingement structure 302 comprising a corrugated configuration.

2. The impingement structure 302 according to claim 1, wherein the impingement structure 302 resides in spaced relation to the target surface 210; and
wherein:
the target-surface comprises an outer surface of a liner 146 and the impingement structure 302 comprises a flow sleeve 144 in a combustor of a combustion turbine engine; or
the target-surface comprises an outer surface of a transition piece 148 and the impingement structure 302 comprises an impingement sleeve 150 in a combustor of a combustion turbine engine.

3. The impingement structure 302 according to claim 1, wherein at a coolant-side of the impingement structure 302 resides a coolant cavity 216 through which, in operation, the flow of coolant is directed so that the coolant is forced against the coolant-side of the impingement structure 302 and thereby impinged through the impingement apertures 214; and at an impingement side of the impingement structure 302 resides the impingement cavity 212.

4. The impingement structure 302 according to claim 3, wherein:
the corrugated configuration comprises a plurality of parallel and alternating ridges 304 and grooves 306;
the ridges 304 comprise a portion of the corrugated configuration that extends toward the target-surface;
the grooves 306 comprise a portion of the corrugated configuration that resides in a recessed position in relation to the target-surface such that the ridges 304 reside closer to the target surface 210 than the grooves 306; and
at least a majority of the impingement apertures 214 are disposed on the ridges 304.

5. The impingement structure 302 according to claim 4, wherein:
along the impingement-side of the impingement structure 302, the ridges 304 comprise a ridge face 316, wherein the ridge face 316 comprises a broad face formed at the outer reaches of the ridges 304 that extends the length of the ridges 304 and is approximately parallel to the target-surface;
along the coolant-side of the impingement structure 302, the ridges 304 comprise a ridge channel 310 that is in flow communication with the coolant cavity 216 through an inlet mouth 312, the ridge channel 310 extending toward the target-surface from the inlet mouth 312 to the ridge face 316; and
along the impingement-side of the impingement structure 302, the grooves 306 comprise a groove channel 320, the groove channel 320 comprising a channel that begins at an outflow mouth 322 and extends away from the target-surface to a floor 324, the floor 324 being positioned a greater distance from the target-surface than the ridge face 316.

6. The impingement structure 302 according to claim 5, wherein:
the ridge channel 310 is configured such that, during operation, the coolant enters the ridge channel 310 at the inlet mouth 312, flows toward the ridge face 316, and exits the ridge channel 310 via the impingement apertures 214;
the groove channel 320 is configured to collect exhausted-coolant after the coolant strikes the target-surface such that the exhausted-coolant enters the groove channel 320 at the outflow mouth 322, collects into the groove channel 320, and then flows along the longitudinal axis of the groove channel 320 toward an outlet 222; and
a longitudinal axis of the grooves 306 are aligned to point toward the outlet 222.

7. The impingement structure 302 according to claim 5, wherein sidewalls 318 extend from each side of the inlet mouth 312 to a corresponding side of the ridge face 316, the sidewalls 318 defining the ridge channel 310 from the inlet mouth 312 to the ridge face 316; and the sidewalls 318 extend from each side of the outflow mouth 322 to a corresponding side of the floor 324, the sidewalls 318 defining the groove channel 320 from the outflow mouth 322 to the floor 324.

8. The impingement structure 302 according to claim 5, wherein:
substantially all of the impingement apertures 214 are disposed on the ridge face 316;
the ridge face 316 is one of substantially flat or slightly curved;
the floor 324 is one of substantially flat or slightly curved; and
the ridge is configured such that the ridge face 316 resides in close proximity to the target-surface.

9. The impingement structure 302 according to claim 7, wherein the corrugated configuration comprises a flared configuration such that:
the ridge channel 310 is narrow at the inlet mouth 312 and the sidewalls 318 of the ridge channel 310 flare outwards from the narrow inlet mouth 312 so that the ridge channel 310 broadens as it nears the backside surface of the ridge face 316; and
the groove channel 320 is narrow at the outflow mouth 322 and the sidewalls 318 of the groove channel 320 flare outwards from the narrow outflow mouth 322 so that the groove channel 320 broadens as it nears the floor 324

10. The impingement structure 302 according to claim 5, wherein the corrugated configuration comprises a rectangular configuration or a sinusoidal configuration; and
wherein, if the corrugated configuration comprises the sinusoidal configuration, the ridge face 316 presents a curved, convex surface to the impingement cavity 212 and the floor 324 presents a curved, concave surface to the groove channel 320.
